(19) United States
(12) Patent Application Publication
(10) Pub. No.: US 2009/0139497 A1
(43) Pub. Date: Jun. 4, 2009

(54) Engine having thin film oxygen separation system

(76) Inventors: Bo Shi, Peoria Heights, IL (US); Marcus Ronald Weber, Peoria, IL (US); Orhan Altin, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/987,530

(22) Filed: Nov. 30, 2007

(51) Int. Cl. F02M 33/00; B01D 53/32; F02B 47/08

(52) U.S. Cl. 123/539; 123/542; 123/567; 123/568.11; 96/80; 96/95; 96/98

(57) ABSTRACT

An oxygen separation system for an engine is disclosed. The oxygen separation system may include a cathode exposed to inlet air, an anode configured to direct a flow of substantially pure oxygen to a combustion chamber of the engine, and a thin film electrolyte located between the anode and the cathode.

### TECHNICAL FIELD

The present disclosure relates generally to an engine and, more particularly, to an engine having a thin film oxygen separation system.

### BACKGROUND

Internal combustion engines, including diesel engines, gasoline engines, natural gas engines, and other engines known in the art exhaust a complex mixture of gaseous products of combustion classified as emissions. The gaseous pollutants may be composed of chemical compounds, which may include nitrogen oxides (NOx). Due to increased attention on the environment, exhaust emission standards have become more stringent, and the amount of pollutants emitted to the atmosphere from an engine may be regulated depending on the type of engine, size of engine, and/or class of engine.

One method that has been implemented by engine manufacturers to comply with the regulation of NOx gases exhausted to the environment has been to reduce the relative amount (i.e. concentration) of nitrogen (N₂) supplied to the engine. Manufacturers have attempted to reduce the relative amount of nitrogen supplied to the engine by providing pure oxygen (O₂) to the intake of the engine, for example, with oxygen-generating chemical compounds and onboard oxygen storage tanks. However, these methods are generally expensive and too large to work practically in an onboard application. Manufacturers have also attempted to use gas permeable polymer membranes to separate nitrogen in the inlet air. However, these membranes are generally incapable of withstanding the high operating temperatures of an internal combustion engine and/or providing a nitrogen-free stream of oxygen.

One alternative method of removing nitrogen from an engine intake system is disclosed in U.S. Pat. No. 6,895,945 (the '945 patent), issued to Parsa. on May 24, 2005. The '945 patent provides an oxygen separation system for the intake of an internal combustion engine. The system includes an inlet and a passageway extending between a first exhaust port and a second exhaust port. At least two gas-permeable electrodes, one an anode and one a cathode, are disposed inside the passageway to define an ionization chamber bounded at opposing ends by the electrodes. When a high-voltage is applied to the electrodes and suction is applied at the exhaust ports, air is drawn into the passageway, and the electric field between the electrodes causes a portion of the air to become ionized. An oxygen enriched stream of air is drawn by suction through the exhaust port nearest the anode and provided to an internal combustion engine. A stream of oxygen depleted air is drawn by suction through the exhaust port nearest the cathode and discharged to the atmosphere.

Although the method of the '945 patent may provide an oxygen enriched gas supply for combustion to an internal combustion engine, the gas supply may not be a stream of pure oxygen. Because the gas provided to the inlet may still contain some nitrogen, NOx gases may be produced during the combustion process and emitted to the atmosphere with the engine exhaust.

The disclosed oxygen separation system is directed to overcoming one or more of the problems set forth above.

### SUMMARY OF THE DISCLOSURE

In one aspect, the present disclosure is directed to an oxygen separation system for an engine. The oxygen separation system may include a cathode exposed to inlet air, an anode configured to direct a flow of substantially pure oxygen to a combustion chamber of the engine, and a thin film electrolyte located between the anode and the cathode.

In another aspect, the present disclosure is directed to a method of operating a power source. The method may include reducing oxygen to form oxygen ions, transporting only the oxygen ions to an inlet of the power source, and oxidizing the oxygen ions to form oxygen. The method may further include combusting the formed oxygen within the power source.

### BRIEF DESCRIPTION OF THE DRAWINGS

FIG. 1 is a pictorial illustration of an exemplary disclosed power source; and

FIG. 2 is a pictorial illustration of an exemplary disclosed oxygen separation system that may be used with the power source of FIG. 1.

### DETAILED DESCRIPTION

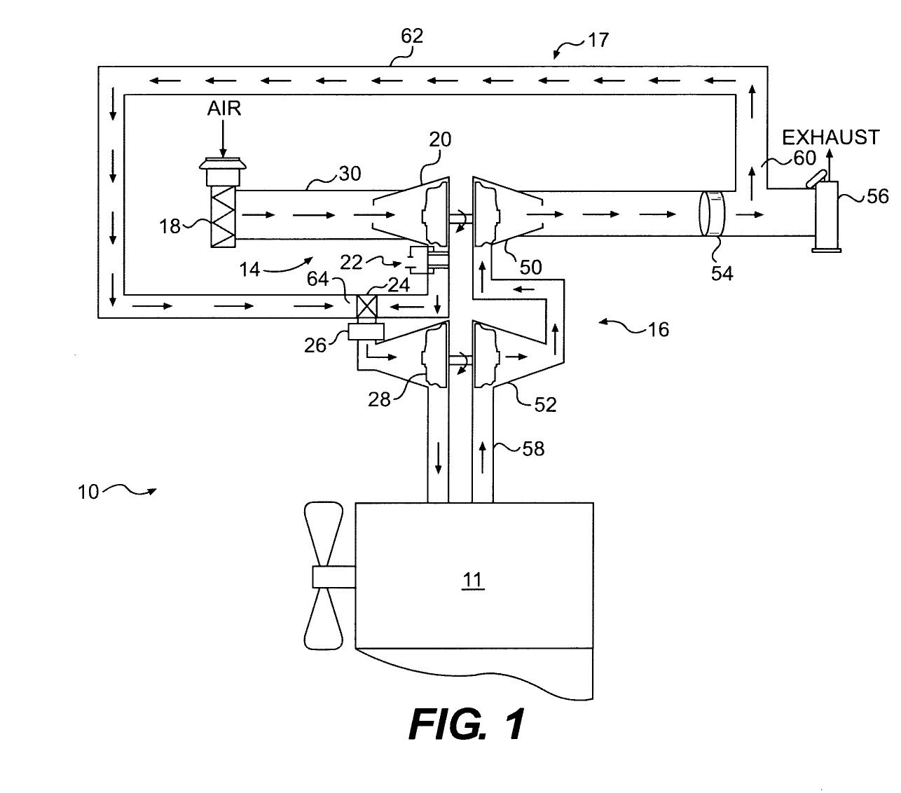

FIG. 1 illustrates an exemplary power source 10. The power source 10 may include an engine 11 such as, for example, a diesel engine, a gasoline engine, a gaseous fuel-powered engine, or any other engine apparent to one skilled in the art. The power source 10 may, alternatively, include a non-engine source of power such as a furnace. The power source 10 may include an induction system 14 that draws combustion gases into the engine 11, an exhaust system 16 that directs exhaust away from the engine 11, and a recirculation system 17 that redirects a portion of the exhaust from the exhaust system 16 back into the induction system 14.

The induction system 14 may include components that cooperate to introduce cleaned and pressurized combustion gases into a combustion chamber (not shown) of the engine 11. Specifically, the induction system 14 may include an air filter 18, a first compressor 20, an oxygen separation system 22, an induction valve 24, a cooler 26, and a second compressor 28. The elements of the induction system 14 may be fluidly connected to direct combustion gases to the engine 11 by way of a fluid passageway 30. It is contemplated that additional components may be included within the induction system 14 such as, for example, additional coolers, additional valving, one or more waste gates, a control system, and other components known in the art.

The air filter 18 may remove or trap debris from air flowing into the engine 11. The air filter 18 may include any type of air filter known in the art such as, for example, a full-flow filter, a self-cleaning filter, a centrifuge filter, or an electro-static precipitator. It is contemplated that more than one air filter 18 may be included within the induction system 14 and disposed in series or parallel relation.

The compressor 20 may compress the air flowing into the induction system 14 to a predetermined pressure. The compressor 20 may embody a fixed geometry type compressor, a variable geometry type compressor, or any other type of compressor known in the art that receives a flow of air and increases the pressure thereof. It is contemplated that more than one compressor 20 may be included and disposed in parallel or in series relation. It is further contemplated that the compressor 20 may be omitted, when a non-pressurized induction system is desired.

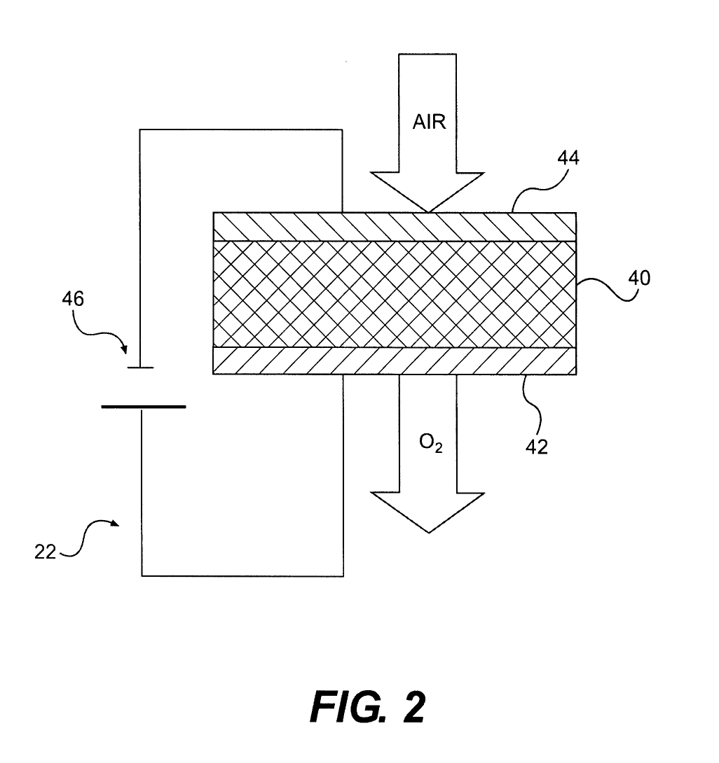

Referring to FIG. 2, the oxygen separation system 22 may include components that receive a flow of nitrogen rich air and output a flow of substantially pure oxygen gas. Specifically, the oxygen separation system 22 may include an electrolyte 40 disposed between two electrodes: an anode 42 and a cathode 44. The electrodes 42, 44 may be connected to a low voltage power supply 46. Power may be supplied, for example, by the engine's battery or alternator (not shown). Although FIG. 2 illustrates a planer embodiment of the oxygen separation system 22, it is further considered that the oxygen separation system 22 may be a tubular oxygen separation system. It is further considered that induction system 14 may include multiple oxygen separation systems, in parallel or series relation, each consisting of an electrolyte 40, anode 42, and cathode 44 connected to the power supply 46.

The electrolyte 40 may be a layer of thin film oxygen ion conductor material. The electrolyte 40 may be fabricated by physical vapor deposition (PVD) or chemical vapor deposition (CVD) and have a thickness of less than 10 um. Specifically, the electrolyte 40 may be a ceramic, solid electrolyte, similar to the materials used in solid oxide fuel cells (SOFC). For example, the thin film electrolyte 40 may be fabricated from yttrium stabilized zirconium (YSZ), gadolinium doped ceria (CGO), lanthanum molybdenum oxide (LAMOX), bismuth vanadium copper oxide (BICUVOX), or lanthanum strontium gallium magnesium oxide (LSGM). The total active area of electrolyte 40 (the sum of the areas of each layer of thin film electrolyte) within the induction system 14 may be about 20 m². It is considered that the use of multiple oxygen separation systems 22, as discussed above, may be required to achieve the desired active area of electrolyte 40 within the induction system 14

The anode 42 and cathode 44 may be porous conductive materials. In particular, the cathode 44 may have both electronic and ionic conductivity and offer enough catalytic activity for oxygen reduction. That is, the cathode 44 may be an oxygen reducer. For example, the cathode 44 may be fabricated from lanthanum strontium cobalt ferrite (LSCF) or lanthanum strontium manganese oxide-yttrium stabilized zirconium (LSM-YSZ). The anode 42 may be a material that has both electronic and ionic conductivity and favors catalytic activity towards oxidation. That is, the anode 42 may be an oxygen ion oxidizer. For example, the anode 42 may be fabricated from a nickel-gadolinium doped ceria (Ni-CGO) cermet material or nickel oxide-yttrium stabilized zirconium (Ni-YSZ).

The materials of the electrolyte 40, anode 42, and cathode 44 should be compatible to provide adequate bonding strength and reduced oxidation and reduction reaction resistance across the material interfaces. Compatible combinations may include, for example: a CGO electrolyte, a Ni-CGO anode 42, and a LSCF cathode 44; or a YSZ electrolyte 40, a Ni-YSZ anode 42, and a LSM-YSZ cathode 44.

The induction valve 24 may regulate the flow of oxygen gas from the oxygen separation system 22 and recirculated exhaust gas from the recirculation system 17 to the engine 11. The induction valve 24 may be a butterfly valve, a gate valve, a ball valve, a globe valve, or any other type of valve known in the art. The induction valve 24 may be solenoid actuated, hydraulically actuated, pneumatically actuated, or actuated in any suitable manner. The induction valve 24 may be in communication with a controller (not shown) and selectively actuated in response to one or more predetermined conditions.

The cooler 26 may function to reduce the temperature of oxygen and exhaust gases provided to the engine 11. The cooler 26 may include a liquid-to-air heat exchanger, an air-to-air heat exchanger, or any other type of heat exchanger known in the art for cooling airflow.

The oxygen separation system 22 and cooler 26 may restrict the flow and, thus, reduce the pressure of inlet gases. As a result, a second compressor 28 may be required to compress the combustion gases flowing into the engine 11 to a predetermined pressure. The compressor 28 may embody a fixed geometry type compressor, a variable geometry type compressor, or any other type of compressor known in the art that receives a flow of gas and increases the pressure thereof.

The exhaust system 16 may include components that direct and/or treat exhaust from the engine 11. In particular, the exhaust system 16 may include a first and a second turbine 50, 52, a particulate filter 54 and an exhaust outlet 56. The elements of the exhaust system 16 may be fluidly connected to direct exhaust away from the engine 11 by way of a fluid passageway 58. The exhaust from the engine 11 may pass through the turbines 52, 50, and the particulate filter 54 to the exhaust outlet 56 before discharging to the atmosphere. It is contemplated that additional emission-controlling devices may be included within the exhaust system 16, if desired.

The turbines 50, 52 may drive the compressors 20, 28, respectively. In particular, as the hot exhaust gases exiting the engine 11 expand against the blades (not shown) of the turbines 50, 52 the turbines 50, 52 may rotate and drive the connected compressors 20, 28. It is contemplated that the turbines 50, 52 may, alternatively, be omitted and the compressors 20, 28 may be driven as a superchargers by the engine 11 mechanically, hydraulically, electrically, or in any other manner known in the art.

The particulate filter 54 may be placed downstream of the turbine 50 to remove particulates from the exhaust. It is also contemplated that more than one particulate filter 32 may be included within the exhaust system 16 and disposed in series or parallel relation. The particulate filter 32 may include a means for regenerating the particulate matter trapped by the particulate filter 32 (not shown). The means for regeneration may include, among other things, a fuel-powered burner, an electrically resistive heater, an engine control strategy, or any other means for regenerating known in the art.

The exhaust outlet 56 may be located downstream of and fluidly connected to the particulate filter 54. The exhaust outlet 56 may direct exhaust flow from the engine 11 to the atmosphere. It is contemplated that an attenuation device, selective catalytic reduction (SCR) device and/or other noise abatement and exhaust treatment devices may be associated with the exhaust outlet 56, if desired.

The recirculation system 17 may include components that interact to treat and redirect a portion of the exhaust flow of the engine 11 from the exhaust system 16 into the induction system 14. That is, the recirculation system 17 may include an inlet port 60, a discharge port 64, and additional components such as, for example, a cooler, an electrostatic precipitator device, a shield gas passageway, valve mechanisms, a control system and other recirculation system components known in the art.

The inlet port 60 may be connected to the exhaust system 16 at the passageway 58 to receive at least a portion of the exhaust flow from the engine 11. A fluid passageway 62 may fluidly communicate exhaust from the inlet port 60 to the discharge port 64. The discharge port 64 may be fluidly connected to the induction valve 24 to direct the exhaust flow into the induction system 14. Specifically, the discharge port 64 may be connected to the induction system 14 downstream of the oxygen separation system 22, such that the recirculated exhaust gas may mix with the oxygen stream provided by the oxygen separation system 22.

### INDUSTRIAL APPLICABILITY

The disclosed oxygen separation system may be applicable to any combustion-type device, such as an engine or a furnace, where the reduction or elimination of NOx engine emissions is desired. The disclosed oxygen separation system may be simple and economical and may provide a substantially pure oxygen stream to a combustion engine so that production of NOx gases during the combustion process may be minimized. The disclosed oxygen separation system may function within the normal operating range of a combustion engine and may include features that minimize combustion temperatures, thereby reducing engine component wear. Operation of the oxygen separation system will now be explained.

Atmospheric air may be drawn into the induction system 14 via the air filter 18 to the compressor 20, where it may be pressurized to a predetermined level before passing through the oxygen separation system 22. The power supply 46 may provide low voltage to the oxygen separation system 22 so that the electrolyte 40 functions as an oxygen pump. The power supply 46 may, for example provide a current density of about 0.2 A per square centimeter of active surface area of thin film electrolyte 40. The total voltage and current may be dependant on the configuration (e.g. parallel or series relation) of the multiple oxygen separation systems 22. It is considered that the voltage required between each anode 42 and cathode 44 may be less than, for example, 2 V. The total power provided by the power supply 46 may be about 5 kW. When power is supplied to the oxygen separation system 22, electrons may flow from the anode 42 through the electrolyte 40 and to the cathode 44. Electrons at the cathode 44 may ionize oxygen atoms to form oxygen ions. The voltage potential across the oxygen separation system 22 may urge oxygen ions through the oxygen ion conducting material of the electrolyte 40. At the anode 42, the oxygen ions may be stripped of their extra electrons to form molecular oxygen. As a result, a substantially pure oxygen stream may be provided at the outlet of the oxygen separation system 22. The reactions at the anode 42 and cathode 44 may be expressed as follows:

Reduction at cathode: O₂+4e⁻=2O²⁻ (Eq. 1)

Oxidation at anode: 2O²⁻−4e⁻=2O₂ (Eq. 2)

The rate at which oxygen is separated from air by the oxygen separation system 22 may be directly proportional to the active area and electro-conductivity of the electrolyte 40. For example, an electrolyte 40 having an active are equivalent to 20 m² may provide about 10 SCFM of oxygen. In addition, electro-conductivity may increase with temperature, which may result in an increase in the rate at which oxygen ions may pass through the electrolyte 40, thereby increasing the oxygen flow rate of the oxygen separation system 22.

After exiting the oxygen separation system 22, the substantially pure oxygen stream may pass through the induction valve 24 where the oxygen stream may be mixed with the exhaust from the recirculation system 17. The proximity of the hot exhaust stream to the oxygen separation system 22 may increase the temperature of the electrolyte 40, thereby increasing the overall oxygen flow rate of the oxygen separation system 22. It is further considered that a heater (not shown) may be provided, in the event that exhaust temperatures do not sufficiently increase the electro-conductivity of the electrolyte 40.

The mixed exhaust and oxygen gases may pass through the cooler 26 and compressor 28 before the gases are drawn into a combustion chamber of the engine 11. Fuel may be mixed with the pressurized gases before or after entering the combustion chamber. This fuel-gas mixture may be combusted by the engine 11 to produce mechanical work and an exhaust flow consisting substantially of carbon dioxide (CO₂) and water vapor. Because oxygen has been separated from the inlet air containing nitrogen at the oxygen separation system 22, substantially no NOx gases are produced by the combustion process.

The exhaust flow may be directed via the fluid passageway 58 to one or more downstream components, such as the turbines 52, 50, and the particulate filter 54. The expansion of the hot exhaust gasses may cause the turbines 52, 50 to rotate, thereby rotating the compressors 28, 20, and compressing the inlet gases.

After exiting the turbine 50, the exhaust gas flow may be directed to the particulate filter 54 where particulate matter entrained with the exhaust flow may be filtered. The particulate matter, when deposited on the particulate filter 54 may be passively and/or actively regenerated in a conventional manner.

As exhaust gas exits the particulate filter 54, the exhaust gas may be divided into two flows, a first flow redirected to the recirculation system 17 and a second flow directed to the exhaust outlet 56. The exhaust directed toward the recirculation system 17 may flow through the inlet port 60 to the induction valve 24, where it may be drawn back into the induction system 14. Combustion temperatures may be lower when the fuel is mixed with CO₂, rather than oxygen. Therefore, reducing the concentration of oxygen in the combustion chamber by introducing CO₂ from the exhaust flow may reduce the combustion temperature within the engine 11. In this manner, the NOx pollution produced by the power source 10 may be reduced without experiencing the harmful effects on engine components caused by excessive temperatures in the combustion chamber of the engine 11.

Several advantages may be associated with the oxygen separation system of the present disclosure. Specifically, the disclosed system may be inexpensive and effective for reducing or eliminating NOx gases produced during the combustion cycle, because only oxygen may be provided to the engine inlet. In addition, the disclosed oxygen separation system may use materials capable of withstanding high temperatures of an engine environment. Furthermore, the disclosed oxygen separation system may not require excessive combustion chamber temperatures, because it may introduce CO₂ to the engine inlet, thereby reducing combustion temperatures.

It will be apparent to those skilled in the art that various modifications and variations can be made to the disclosed oxygen separation system. Other embodiments will be apparent to those skilled in the art from consideration of the specification and practice of the disclosed oxygen separation system. It is intended that the specification and examples be considered as exemplary only, with a true scope being indicated by the following claims and their equivalents.

What is claimed is:

1. An oxygen separation system for an engine comprising:
a cathode exposed to atmospheric air;
an anode configured to direct a flow of substantially pure oxygen to a combustion chamber of the engine; and
a thin film electrolyte located between the anode and the cathode.

2. The oxygen separation system of claim 1, wherein the cathode is an oxygen reducer.

3. The oxygen separation system of claim 1, wherein the thin film electrolyte is an oxygen ion conductor.

4. The oxygen separation system of claim 1, wherein the anode is an oxygen ion oxidizer.

5. The oxygen separation system of claim 1, wherein the thin film electrolyte is configured to transport only oxygen ions from the cathode to the anode.

6. The oxygen separation system of claim 1, wherein the thin film electrolyte is formed by one of physical vapor deposition or chemical vapor deposition.

7. The oxygen separation system of claim 1, wherein the thin film electrolyte includes at least one of yttrium stabilized zirconium, gadolinium doped ceria, lanthanum molybdenum oxide, bismuth vanadium copper oxide, or lanthanum strontium gallium magnesium oxide.

8. The oxygen separation system of claim 1, further including a power supply configured to generate a low voltage potential between the anode and the cathode.

9. The oxygen separation system of claim 8, wherein the power supply is configured to supply power at about 0.2 A per square centimeter of an active area of the thin film electrolyte.

10. The oxygen separation system of claim 1, wherein the anode is one of nickel-gadolinium doped ceria cermet and nickel oxide-yttrium stabilized zirconium.

11. The oxygen separation system of claim 1, wherein the cathode is one of lanthanum strontium cobalt ferrite and lanthanum strontium manganese oxide-yttrium stabilized zirconium.

12. The oxygen separation system of claim 1, further including a flow of engine exhaust configured to increase an electro-conductivity of the thin film electrolyte.

13. A power system comprising:
an engine;
an induction system configured to direct combustion gases into the engine;
an oxygen separation system, wherein the oxygen separation system includes:
an oxygen reducer located at an atmospheric inlet of the induction system;
an oxygen ion oxidizer spaced at a distance from the oxygen reducer; and
a thin film electrolyte located between the oxygen reducer and the oxygen ion oxidizer.

14. The power system of claim 13, further including an exhaust recirculation system configured to receive at least a portion of a flow of exhaust from the engine and recirculate the exhaust to a combustion chamber of the engine, wherein at least a portion of the flow of exhaust is mixed with a substantially pure flow of oxygen from the induction system, prior to recirculation into the combustion chamber of the engine.

15. The power system of claim 14, further including a cooler, wherein the mixture of the portion of the flow of exhaust and the flow of oxygen from the induction system pass through the cooler prior to entering the combustion chamber of the engine.

16. The power system of claim 13, further including multiple oxygen separation systems disposed in serial or parallel relation.

17. The power system of claim 16, wherein a sum of the areas of each thin film electrolyte is about 20 square meters.

18. A method of operating a power source comprising:
reducing oxygen from atmospheric air to form oxygen ions;
transporting the oxygen ions to an inlet of the power source;
oxidizing the oxygen ions to form molecular oxygen; and
combusting the molecular oxygen within the power source.

19. The method of claim 18, wherein transporting includes conducting the oxygen ions with a low voltage.

20. The method of claim 18, further including mixing exhaust gases from the power source with the molecular oxygen and cooling the exhaust gases and the molecular oxygen, before combusting the molecular oxygen.
